(19) United States
(12) Patent Application Publication
(10) Pub. No.: US 2013/0022435 A1
(43) Pub. Date: Jan. 24, 2013

(54) LOW PROFILE WHEEL LIFT

(71) Applicants: David W. Bannon, Chattanooga, TN (US); James Todd Colling, Chattanooga, TN (US); Jonathan Squires, Ooltewah, TN (US)

(72) Inventors: David W. Bannon, Chattanooga, TN (US); James Todd Colling, Chattanooga, TN (US); Jonathan Squires, Ooltewah, TN (US)

(73) Assignee: MILLER INDUSTRIES TOWING EQUIPMENT INC., Ooltewah, TN (US)

(21) Appl. No.: 13/188,316

(22) Filed: Jul. 21, 2011

(51) Int. Cl. B60P 3/12

(52) U.S. Cl. 414/563

(57) ABSTRACT

A low profile wheel lift having a new crossbar/boom pivot connection enabling a recovery vehicle to quickly engage a disabled vehicle to facilitate damage-free towing to a degree not previously possible.

### BACKGROUND OF THE INVENTION

The present invention generally relates to devices for lifting and towing vehicles by a pair of the vehicle wheels, known as wheel lifts. More particularly, the invention is directed to a self-loading wheel lift with a low profile to facilitate damage-free towing.

Wheel lifts are well known in the towing industry. See, e.g., commonly assigned U.S. Pat. Nos. 4,637,623 and 4,798,509 to Alm, each entitled “Towing Apparatus,” U.S. Pat. No. 4,836,737 to Holmes entitled “Wheel Lift Tow Assembly,” U.S. Pat. No. 4,564,207 to Russ et al., entitled “Hydraulic Wheel Lift System For Tow Vehicles,” and U.S. Pat. No. 7,494,313 to Craze, entitled “Wheel Lift That May Be Rapidly Disassembled And Converted,” each of which are incorporated by reference in their entirety into this application.

For years the standard hydraulic self-loading wheel lift, such as depicted in U.S. Pat. No. 4,564,207 to Russ et al., has enjoyed a specific usage in the towing industry. Such self-loading wheel lifts are capable of automatically loading automobiles in seconds with ease and permitting operators to remain in the safe environment of their cab. The typical assembly of such wheel lifts includes a hydraulically-operated, rearwardly-extending boom or “stinger” roughly 80 inches long for capturing the towed vehicle's tires. Two wheel support members such as L-shaped arms may be pivotally attached to the cross bar, swinging from inside and then outwardly to capture a towed vehicle's tires. Hydraulic cylinders may power L-arm movement.

Self-loading wheel lifts suffer from several disadvantages. First, while their current height profile is relatively thin—5½ inches for the crossbars of several industry-standard models—a thinner crossbar profile would facilitate damage-free towing, and better allow the wheel lift to avoid damaging the towed vehicle's lowest points, such as the oil pan, transmission and axle mounts. Second, self-loading wheel lifts, particularly those with a relatively thin profile, suffer from durability issues, particularly those stemming from the pivot point at which the rear portion of the stinger pivotally connects to the crossbar, which is the point on the crossbar which limits the height profile. For decades, this pivotal connection has consisted of either upper and lower plates which form the stinger's distal end, together with a centered, pressed-in bushing (the Century-type stinger), or a single grooved pivot head with a center aperture (the Vulcan-type stinger). With either design, the crossbar is then attached to the stinger by bolting or pinning these plates or pivot head to corresponding plates on the crossbar (see prior art FIGS. 1-4, showing Century-type and Vulcan-type stingers and corresponding crossbars).

Manufacturer efforts to further shrink the crossbar height profile over the last several decades have met with difficulties. Stronger materials which are also workable and economical to use are not currently available (Domex steel with a 100 ksi yield has been used). Increasing the surface area of the pivot heads and plates is not desirable from an engineering standpoint, as this increases the moment arm for the stinger-crossbar pivotal connection, increasing the torsional forces acting on this connection, which is undesirable.

Accordingly, it would be advantageous to provide a self-loading wheel lift that overcomes the current disadvantages of such wheel lifts, by providing a new wheel lift that meets industry standards for strength and durability while providing a substantially thinner profile for enhanced damage-free towing, and that provides other advantages as well as discussed below, while preserving the loading advantages of current self-loading wheel lifts on the market. The invention also preferably may be used with conventional, manual-loading wheel lifts, as well.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Manual-loading wheel lift” refers to a wheel lift capable of engaging and lifting a towed vehicle by its wheels by manually placing wheel support members to engage the wheels of the towed vehicle.

“Self-loading wheel lift” refers to a wheel lift capable of engaging and lifting a towed vehicle by its wheels, without the necessity of manually placing wheel support members to engage the wheels of the towed vehicle, but rather by positioning the wheel support members through control by an operator located in the recovery vehicle.

“Wheel lift” means any device designed to lift and tow vehicles through sole or substantial support by the wheels of the towed vehicle.

### SUMMARY OF THE INVENTION

The objects mentioned above, as well as other objects, are solved by the present invention, which overcomes disadvantages of prior wheel lifts, while providing new advantages not believed associated with such devices, including those advantages listed above as well as other advantages as well.

The present invention involves the counter-intuitive solution of removing mass at the stinger/crossbar pivot connection while increasing the number of plates and pivot heads that make up this pivot connection.

In a preferred embodiment of the present invention, a low-profile wheel lift apparatus is provided for use in lifting and towing a disabled vehicle by its wheels from the rear of a recovery vehicle. The wheel lift apparatus may include a movable, rearwardly-extending boom capable of extending from the rear of the recovery vehicle, and a transverse crossbar pivotably connected to a distal end of the boom at a rearward end of the recovery vehicle, positionable below the disabled vehicle. The crossbar may have two opposing end portions connected to wheel lifts positionable adjacent a pair of wheels on the disabled vehicle. Dual, rearwardly-extending upper and lower pivot heads may extend from the boom. The crossbar may have upper and lower plates and an intermediate plate interposed between the upper and lower plates, with these crossbar plates each extending forwardly from the crossbar. Preferably, then, the boom-crossbar pivotal connection is a hinged connection in which the upper pivot head of the boom may be located and constrained between the upper and the intermediate plates of the crossbar, and the lower pivot head of the boom may be located and constrained between the intermediate and the lower plates of the crossbar. Using this design approach, a crossbar may be provided that has a maximum height (at the pivotal connection to the boom) in the range of between about 4 inches and 4½ inches and, most preferably, about 4¼ inches.

Wheel lifts usable with the present invention may either be self-loading wheel lifts, or manual-loading wheel lifts. The boom may be hydraulically powered and may be permitted to extend or retract longitudinally relative to a longitudinal axis of the recovery vehicle. The crossbar may be pivotable relative to the boom in a horizontal plane generally parallel to the ground. The wheel lifts may also be pivotable relative to the crossbar in a horizontal plane generally parallel to the ground.

In another embodiment of the invention, the crossbar may include a recess on a side opposite the pivot connection to facilitate clearance of the underside carriage of the disabled vehicle during connection of the wheels of the disabled vehicle to the wheel lifts of the recovery vehicle.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings. The drawings illustrate currently preferred embodiments of the present invention. As further explained below, it will be understood that other embodiments, not shown in the drawings, also fall within the spirit and scope of the invention.

FIG. 1 is a perspective view of a prior art Vulcan-type stinger with grooved pivot head;

FIG. 2 is a perspective view of a prior art Vulcan-type crossbar with conventional, manual pivotable L-arms with wheel scoops, the crossbar having centered upper and lower plates designed to pivotally connect to the Vulcan-type grooved pivot head shown in FIG. 1;

FIG. 3 is a perspective view of a prior art Century-type stinger terminating in a pivot head having a pressed-in bushing;

FIG. 4 is a perspective view of a prior art Century-type crossbar with centered upper and lower plates designed to pivotably connect to the Century-type pivot head shown in FIG. 3;

FIG. 5 is an enlarged, partial top and side perspective view showing the boom-crossbar pivotal, hinged connection for a preferred embodiment of the present invention;

FIG. 6 is a partial side and front perspective view of a center portion of the crossbar for the preferred embodiment of the invention shown in FIG. 5;

FIG. 7 is an enlarged, partial front and side perspective view of a distal end of the boom/stinger, showing, in a preferred embodiment of the invention, dual, grooved pivot heads;

FIG. 8 is a planar perspective view of the dual pivot heads on the boom/stinger shown in FIG. 7;

FIG. 9 is a planar, top and front perspective view of a preferred embodiment of the crossbar with L-arms of the present invention;

FIG. 10 is an enlarged planar perspective view of the pivot pin with internal snap ring which may be used to pivotally connect the boom pivot heads and the crossbar plates, in a preferred embodiment of the present invention;

FIG. 11 is a bottom perspective view of the boom/crossbar pivot pin when the boom is in a fully retracted position;

FIG. 12 is a top and side perspective view of a preferred embodiment of the invention, showing the wheel lift members disassembled from the crossbar;

FIG. 12A is a view similar to FIG. 12 showing, with arrows, the directions in which the crossbar and the wheel lift members may be pivoted;

FIGS. 13 and 13A are views similar to FIGS. 12 and 12A showing a preferred embodiment of the invention, in which the wheel lifts are assembled to the crossbar;

FIG. 13B is a sectional view taken along reference line 13A-13A of FIG. 13A;

FIG. 14 is a top perspective view of a preferred embodiment of the invention; and

FIG. 14A is a partial view of FIG. 14, showing the pivotable operation of the crossbar relative to the boom.

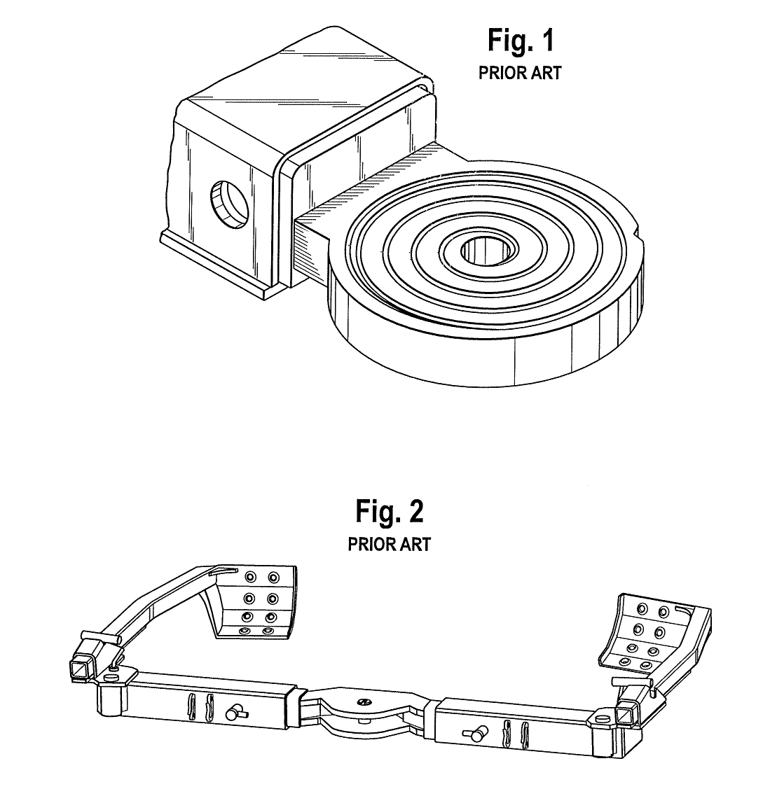

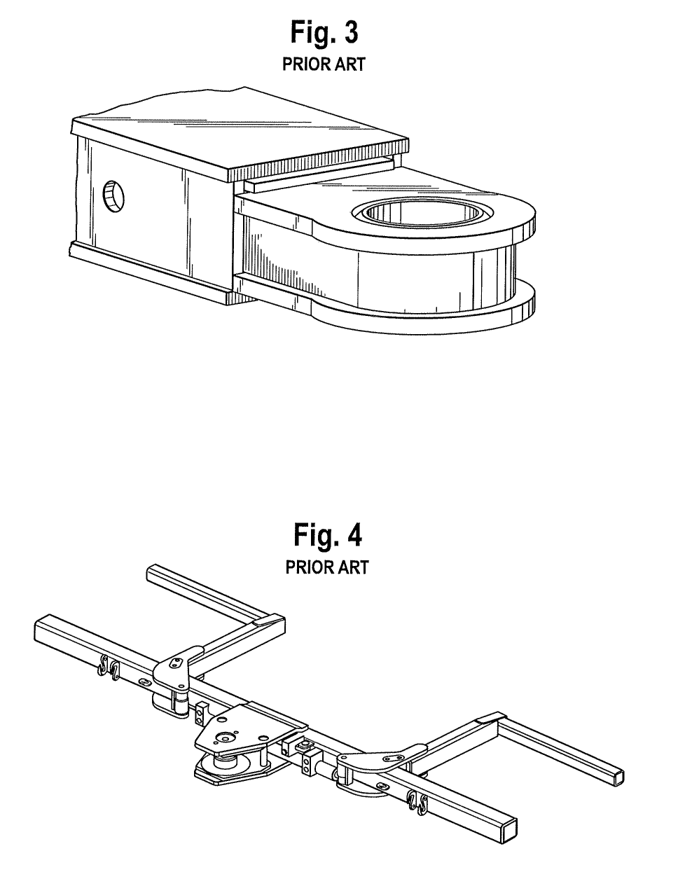

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are currently believed to be the preferred embodiments and/or best examples of the invention claimed. Future and present alternatives and modifications to these preferred embodiments are contemplated. Any alternatives or modifications which make insubstantial changes in function, in purpose, in structure or in result are intended to be covered by the claims of this patent.

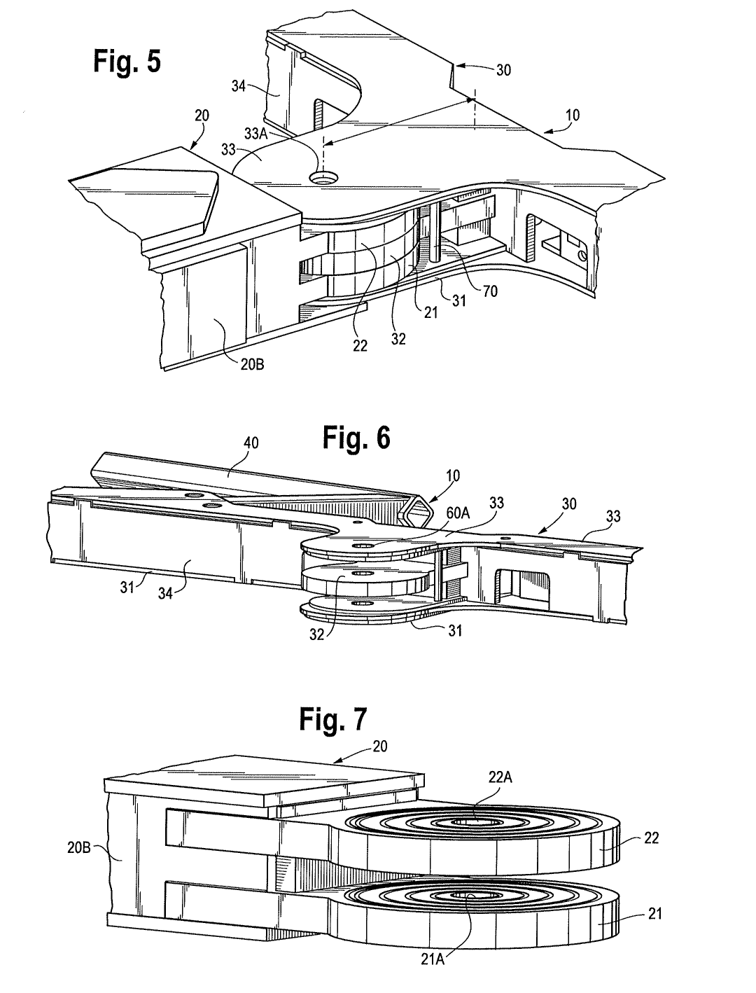

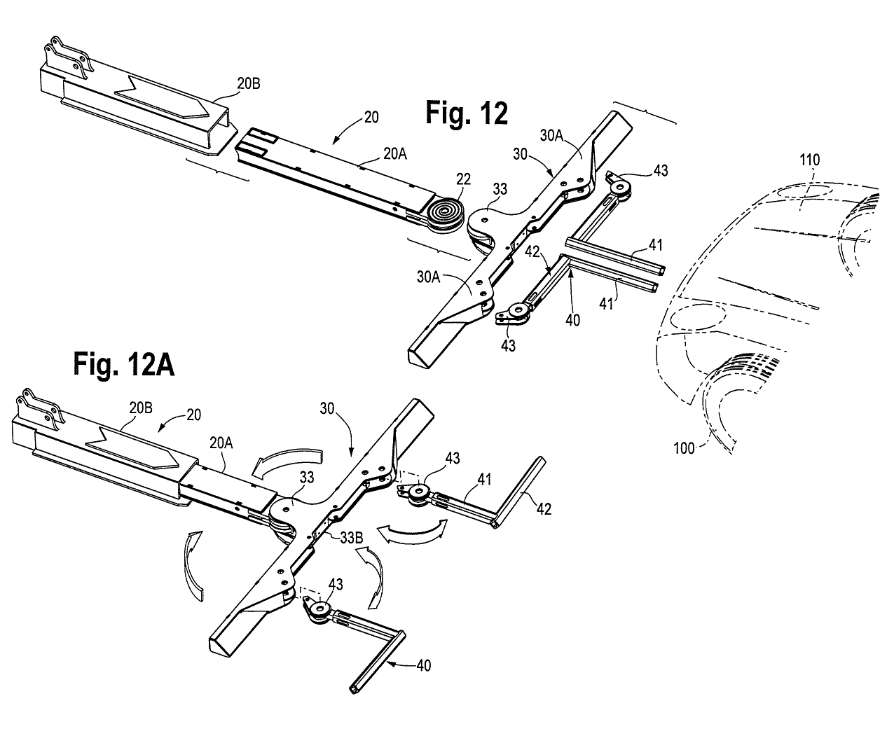

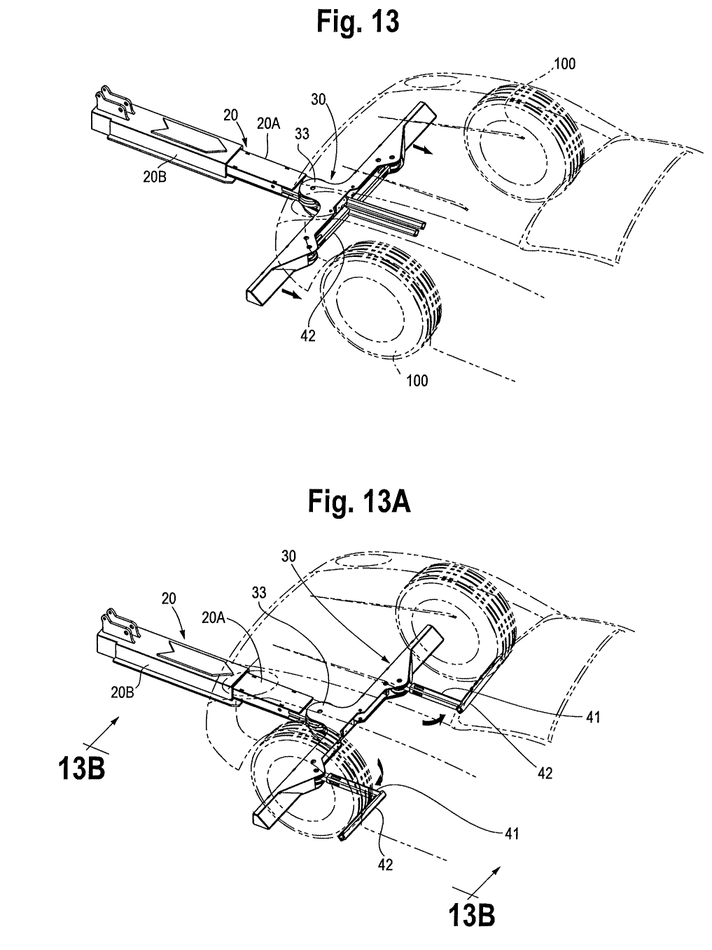

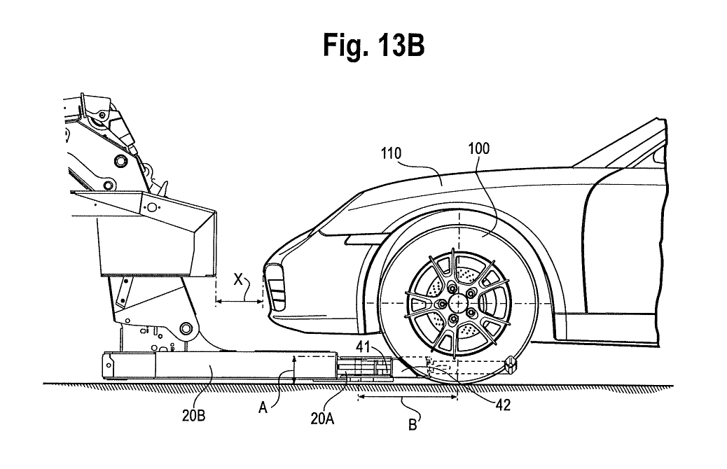

Referring to FIGS. 5-9, a preferred embodiment of the wheel lift apparatus of the present invention is shown, designated generally with the reference numeral 10. Wheel lift apparatus 10 preferably includes a boom assembly extending rearwardly from a towing vehicle (see FIGS. 12-13). The boom assembly may include an articulating, hydraulically-powered boom 20, pivotally connected to a transverse support or crossbar 30, which may be rectangular or curved in cross-section. Referring to FIGS. 12 and 12A, boom 20 may include a telescoping inner boom arm 20B moving within boom main arm 20A.

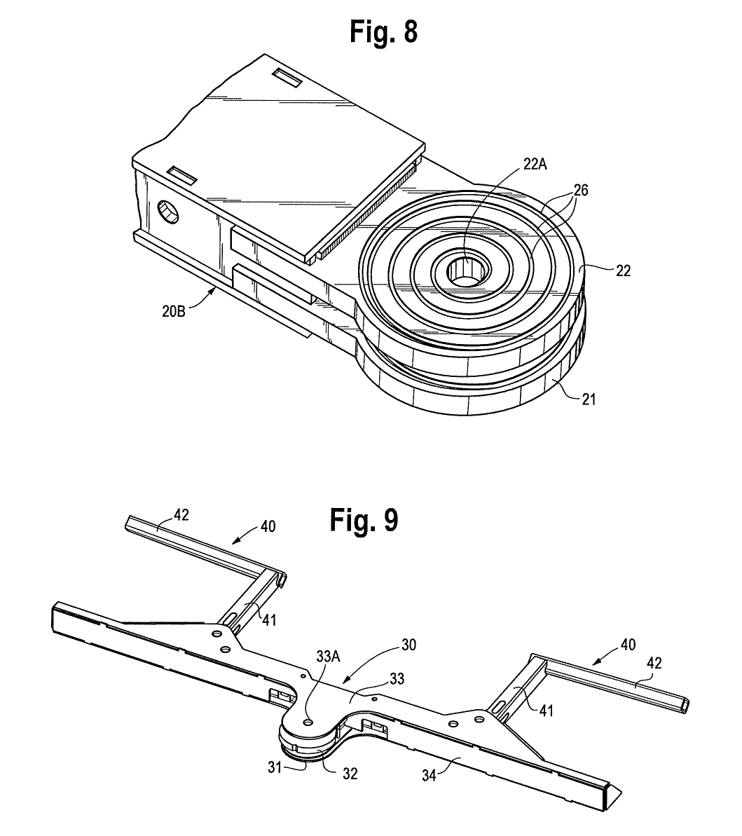

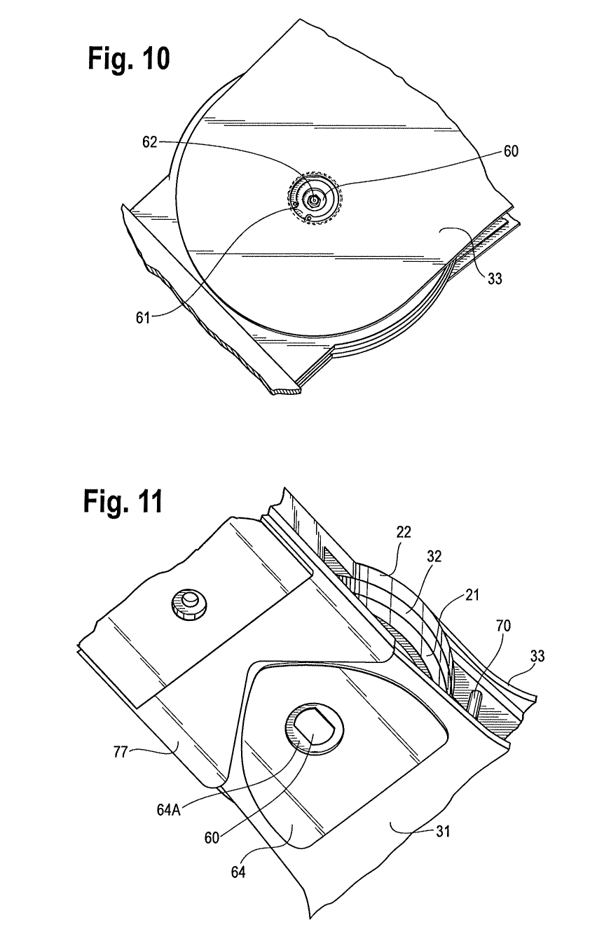

In a preferred embodiment of the invention, the distal end of boom 20, telescoping boom arm 20A (FIG. 13), may rearwardly terminate in lower and upper pivot heads 21, 22 which may be rigidly attached to the boom. Pivot heads 21, 22 may include grooves 26 (FIG. 8) to distribute and maintain grease for smooth rotation. The middle, front end of crossbar 30 may terminate in lower, intermediate and upper plates 31, 32 and 33. Each pivot head and plate may have a center aperture (21A, 22A, 31A, 32A and 33A) for commonly receiving pivot pin 60 (see FIGS. 10 and 11). To maintain the lowest/thinnest possible profile, the upper end of pivot pin 60 may be secured with an internal snap ring 61 (FIG. 10), while the lower end of pivot pin 60 may be secured using groove keeper plate 64 having slot 64A (used to keep pivot pin 60 from rotating); plate 64 is preferably welded to plate 31.

Referring to FIG. 11, when the boom is in a fully retracted position (such as used for towing a disable vehicle down the road), the crossbar may be kept in a relatively square and centered position relative to the longitudinal axis of the tow truck by the interaction of crossbar plate 64 and boom plate 77, which forms an automatic centering device to properly orient the crossbar when the stinger/boom is retracted. Grease fitting 62 may be employed to facilitate maintenance of grooved surfaces 26. Referring to FIG. 5, a stop or detent 70 may be provided on either side of the boom/crossbar pivotal connection to limit the rotation of the crossbar relative to the boom.

As is well known in the art, an L-arm 40, which may include leg 41 and wheel-engaging bar 42 (FIG. 9), or other known wheel lift apparatus, may be pivotally attached to opposing ends of crossbar 30, allowing the L-arms to swivel in a horizontal plane. Pivotal rotation or swiveling of the L-arms in a horizontal plane generally horizontal to the ground may be accomplished using hydraulic cylinders, for example, as is also well known in the art. Telescoping and pivoting boom movement, as well as swiveling movement of the L-arms to load and unload a disabled vehicle, may be controlled remotely by an operator in a cab of the recovery vehicle, for example.

Stress analyses of the preferred embodiment shown in the drawings indicates that during hook-up and transport of a disabled vehicle, the maximum stress on top plate 33 occurs on the innermost portion of the plate (closest to wheel lifts 40), while the maximum stress on bottom plate 31 occurs on the outermost portion of the plate (farthest from wheel lifts 40). As maximum stresses on intermediate plate 32 occur on both the outermost and innermost portions of the plate, it is believed that the intermediate plate balances the stresses received from the upper and lower plates.

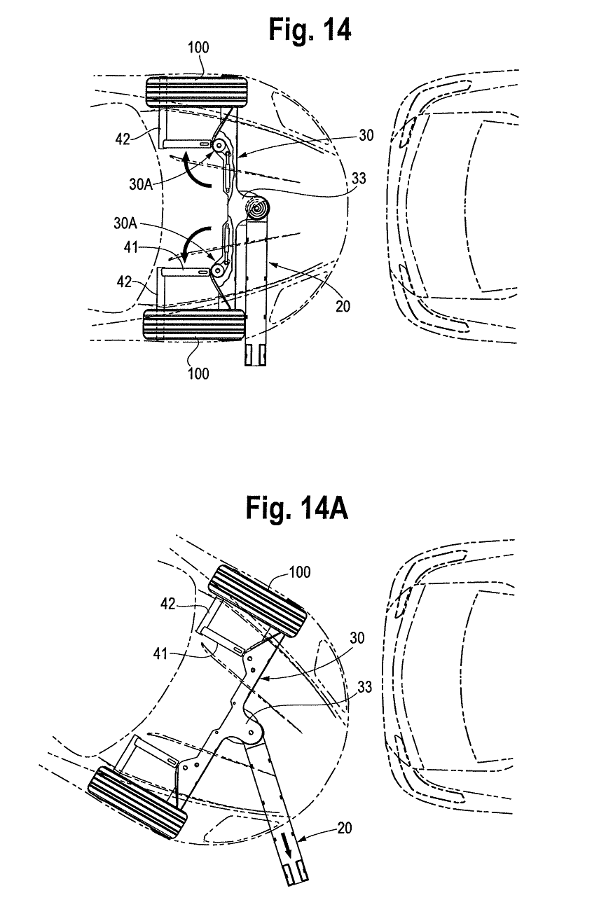

Referring now to FIGS. 12-14, the ends of wheel lift legs 41 terminate in pivot plates 43 pivotally attached to the ends of crossbar 30 at locations 30A as is well known in the art. This allows the wheel lift arms to swing inwardly and outwardly so that the wheel lift arms may be positioned beneath wheels 100 of disabled vehicle 110 (FIG. 12).

To provide further information to those of ordinary skill in the art, the following exemplary dimensions occurring in a working prototype are discussed. (For the numbers given here, the distance from the front face of the wheel-lift boom to the rear face of the crossbar was measured.) Referring to FIG. 13B, the maximum height A of the crossbar occurs at the pivot pin, and using the principles of the present invention this maximum height has been reduced to 4¼ inches. The boom may be, for example, 61¾ inches long in its retracted position, and 95½ inches long in its fully telescoped position. Referring to FIG. 13B, in a preferred embodiment, an exemplary distance X between the tailgate of the recovery vehicle to the front bumper of the disabled vehicle is 13.08 inches. Further, an exemplary distance Y between the pivot pin 60 to the centerline of the front wheels of the disabled vehicle is 19.72 inches.

Those of ordinary skill in the art will appreciate one or more of various advantages may flow from different embodiments of the self-loading wheel lift apparatus of the present invention, including: its new and unique hinge-style pivot; the recessed pivot pins with internal snap rings at the top and groove keeper slots at the bottom; the enclosed crossbar design to protect the hydraulic system components (cylinders, hoses and valves); the low-profile design (a desirable maximum thickness of 4¼ inches) for access to the widest range of vehicles in the market, including those with very low ground clearance; and the recessed cavity in the center to prevent towed vehicle oil pan damage.

It will be understood that self-loading wheel lifts with alternative functions may be designed according to the principles of the present invention. For example, as a less desirable solution, the pivot connection could consist of three stinger plates and four crossbar plates. As a further example, movement of the wheel support members may be powered using alternative mechanisms other than hydraulic cylinders, such as pneumatic cylinders, electric motors/solenoids, chains, rope, etc. Rapid disassembly and conversion capabilities could be provided, as with U.S. Pat. No. 7,494,313. Preferably, self-loading wheel lifts according to the present invention retain the ability to rapidly engage a towed vehicle's wheel from the inside out.

Referring now to FIGS. 9, 12A and 13A, crossbar 30 may be recessed such as with notch 33B, to enable the low-profile crossbar to provide better clearance for (e.g.) the oil pan or other low-profile features on the underside of the disable vehicle. In the exemplary embodiment, the recess/notch is centered on the crossbar pivot connection and its dimensions may be approximately eight inches long and one and one-half inches deep.

The above description is not intended to limit the meaning of the words used in the following claims that define the invention. Rather, it is contemplated that future modifications in structure, function or result will exist that are not substantial changes and that all such insubstantial changes are intended to be covered by the following claims.

We claim:

1. A low profile wheel lift apparatus for use in lifting and towing a disabled vehicle by its wheels from the rear of a recovery vehicle, comprising:
a movable, rearwardly-extending boom capable of extending from the rear of the recovery vehicle;
a transverse crossbar pivotably connected to a distal end of the boom at a rearward end of the recovery vehicle, the crossbar being positionable below the disabled vehicle, the crossbar having two opposing end portions connected to wheel lifts positionable adjacent a pair of wheels on the disabled vehicle;
dual, rearwardly-extending upper and lower pivot heads extending from the boom;
the crossbar having upper and lower plates and an intermediate plate interposed between the upper and lower plates, the plates each extending forwardly from the crossbar;
wherein the boom-crossbar pivotal connection comprises a hinged connection in which the upper pivot head of the boom is located and constrained between the upper and the intermediate plates of the crossbar, and the lower pivot head of the boom is located and constrained between the intermediate and the lower plates of the crossbar.

2. The low profile wheel lift apparatus of claim 1, wherein the crossbar has a maximum height in the range of between about 4 inches and 4½ inches.

3. The low profile wheel lift apparatus of claim 1, wherein the crossbar has a maximum height of about 4¼ inches.

4. The low profile wheel lift apparatus of claim 1, wherein the wheel lifts comprise self-loading wheel lifts.

5. The low profile wheel lift apparatus of claim 1, wherein the wheel lifts comprise manual-loading wheel lifts.

6. The low profile wheel lift apparatus of claim 1, wherein the boom is hydraulically powered and can extend or retract longitudinally relative to a longitudinal axis of the recovery vehicle.

7. The low profile wheel lift apparatus of claim 1, wherein the crossbar is pivotable relative to the boom in a horizontal plane generally parallel to the ground.

8. The low profile wheel lift apparatus of claim 1, wherein the wheel lifts are pivotable relative to the crossbar in a horizontal plane generally parallel to the ground.

9. The low profile wheel lift apparatus of claim 1, wherein the crossbar includes a recess on a side opposite the pivot connection to facilitate clearance of the underside carriage of the disabled vehicle during connection of the wheels of the disabled vehicle to the wheel lifts of the recovery vehicle.
